(19) United States
(12) Patent Application Publication
(10) Pub. No.: US 2008/0013328 A1
(43) Pub. Date: Jan. 17, 2008

(54) Yieldable support for a mailbox

(76) Inventor: Anthony J. Newbill, Wickenburg, AZ (US)

Correspondence Address: James D. Givnan, Jr., 8175 S.W. Ernst Road, Portland, OR, 97225, US

(21) Appl. No.: 11/487,674

(22) Filed: Jul. 17, 2006

(51) Int. Cl. F21S 13/10

(52) U.S. Cl. 362/431; 362/153; 362/285

(57) ABSTRACT

A post structure for installation along a street or road with a base supporting the post structure in a yieldable manner. A coupling joining the base and post structure includes a resilient member urging the post structure into a normal, pre-determined position on the base. An upper end of the base serves as a fulcrum for momentary post structure movement. A modified form of the yieldable support includes a housing with spring and fastener assembly with the housing having inclined surfaces which cooperate with inclined surfaces on the base upper end, insuring return of the tipped post structure back to the pre-determined relationship with the base after momentary displacement.

### BACKGROUND OF THE INVENTION

The present invention concerns a support structure for an article such as a mailbox or other article, and those structures may yield upon being subjected to sudden impacts.

In the case of mailbox supports, such as are found in rural areas, located adjacent streets, roadways, etc., the support is often a post. Accordingly, the post and mailbox are highly susceptible to damage by snow plows, road graders automobiles, etc. Further, typical mailbox supports are most often strictly utilitarian, without regard to enhancing a home site.

U.S. Pat. No. 7,032,811 discloses a mailbox support, including a post segment terminating downwardly within a coil spring while a ground inserted secondary post segment extends upwardly, into the coil spring to permit movement of the first mentioned post segment upon impact. Provision is made for rotational displacement of a post supported mailbox about a vertical axis.

U.S. Pat. No. 4,792,088 discloses a mailbox support with post segments being spaced apart by a spring assembly, including a socket at one end and an insert at the opposite spring end for post engagement.

U.S. Pat. No. 5,029,783 discloses a post wherein upper and lower post segments are held in axial alignment by an extension spring member with ends secured to the post segments. A cover protects cooperating rings 32, 34. Variations in the action of a spring 50 entails substitution of the spring.

U.S. Pat. No. 5,215,283 discloses a mailbox support with a horizontal arm, supporting multiple mailboxes, which may swing upon impact to wind or unwind a coil spring 24 to automatically return the mailboxes to an operative position.

U.S. Pat. No. 3,161,397 discloses a mailbox supporting arm which, upon impact, may rotate to move against the action of a spiral spring, which subsequently returns to an operative position as determined by stops 27-28.

U.S. Pat. Nos. 3,658,284; 3,899,150 and 4,172,579 all include spring components for relocating a mailbox and a supporting horizontal arm in perpendicular relationship to a street or roadway but fail to show any protective means for a mailbox post against damage from an impacting force.

### SUMMARY OF THE PRESENT INVENTION

The present invention is directed toward providing a sturdy support for such items as roadside located mailboxes or other structures subjected to significant forces. The present post structure may yield with substantial displacement to lessen damage to the post with return of the post structure to its normal disposition with little or no manual effort. A component of the present support structure permits momentary tipping of the post structure through a wide range of movement about multiple axes. Dual upright components of the post structure may be reinforced by a plate mounted therebetween. Inclined post members permit a wide range of travel of the support when contacted by a vehicle or other source of impact.

A modified form of the present support is particularly suitable for areas experiencing high winds that result in tipping of the support in an oscillating manner. The modified form includes cooperating surfaces on the post or base and at the lower end of the support structure which serves to maintain the post structure against rotational displacement during tipping of the support structure in response to wind or other force.

### BRIEF DESCRIPTION OF THE DRAWINGS

In the accompanying drawings:

FIG. 1 is a side elevational view of the present support structure;

FIG. 2 is an enlarged fragmentary view of the present post structure;

FIG. 3 is an elevational view taken along line 3-3 of FIG. 2;

FIG. 4 is a schematic of base and post components with tipped positions of the post shown in broken lines.

FIG. 5 is a view similar to FIG. 2 but showing a modified form of the support.

FIG. 6 is a horizontal sectional view taken along line 6-6 of FIG. 5.

FIG. 7 is an elevational view of a support structure modified for use as a sign post.

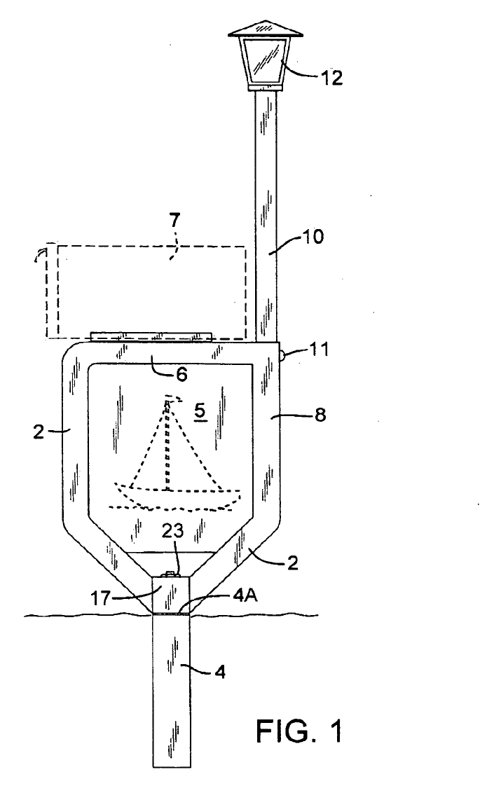

### DETAILED DESCRIPTION OF THE PREFERRED EMBODIMENTS

With continuing attention to the drawings, the applied reference numeral 1 indicates generally a support shown in conjunction with a mailbox.

A post component 2 is in supported contact with an upper end surface 4A of a base 4. Post component 2 is of tubular construction and preferably includes a reinforcing plate 5. Plate 5 may also serve decorative purposes. A horizontal post member 6 serves as a support for a mailbox 7. An upright member 8 of the post may serve to receive a light post 10 having a lower end portion in inserted engagement with the upright member and held in place as by a set screw 11. A lantern at 12 is preferably of the solar powered type to illuminate any information such as an owner's name or a street number on plate 5.

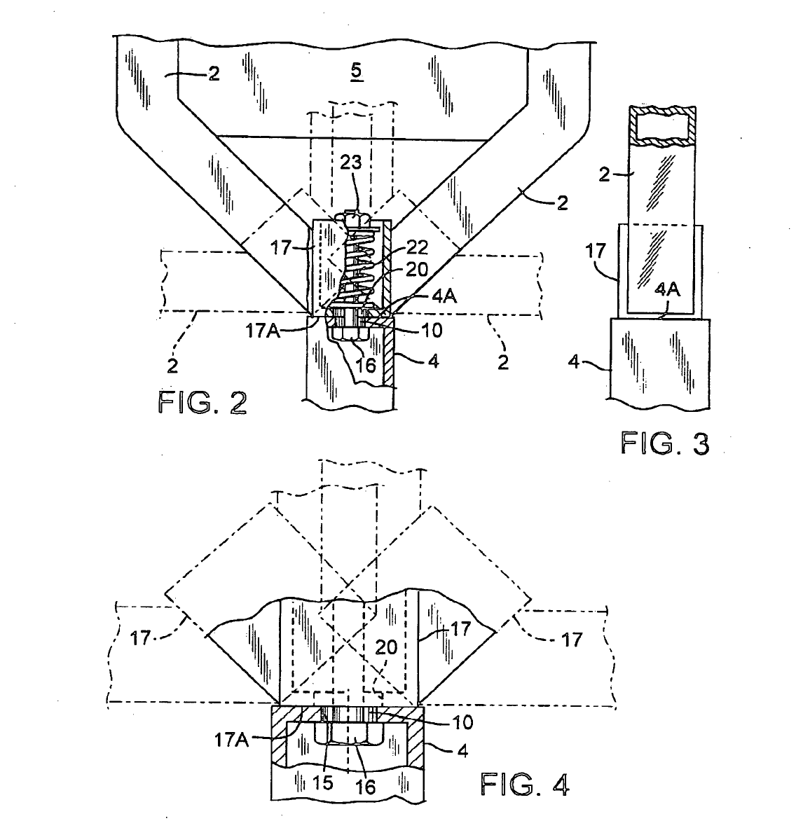

Base 4 may also be of tubular construction, having top end 4A (FIG. 2) centrally apertured at 10 to receive a fastener 16. A housing 17 on post component 2 has a bottom wall 17A is in supported engagement with surface 4A of base 4. Housing bottom wall 17A is apertured at 20 to receive fastener 16 which extends upwardly through a compression spring 22 to receive a nut and washer at 23. The spring bottom end is supported by end 17A of the housing. Adjustment of nut serves to urge housing 17 into frictional engagement with surface 4A of base 4. It is to be noted that the openings 15 10 and 20 in bottom 17A are oversize for the shank of fastener 16.

With attention to FIG. 4, it will be seen that housing 17, upon a laterally applied force being applied to post component 2, will rock about a housing edge as at 23. FIG. 4 shows, in broken lines, movement of housing 17 with component 2 displaced in opposite directions and shown for illustrative purposes only. Surface 4A of base 4 functions as a fulcrum when housing 17 is displaced.

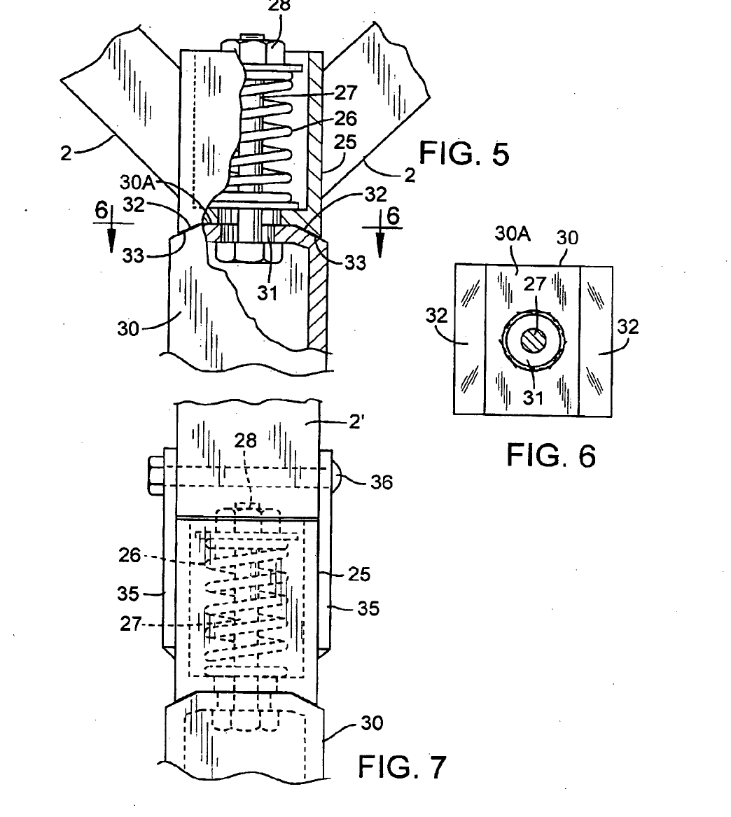

With attention to FIG. 5 and FIG. 6, a modified form of the present support includes a housing 25 to house a compression spring 26 and a fastener 27 terminating in a nut and washer assembly 28. Post component 2 is carried by a housing 25. A base 30 with an opening 31 receives the head of fastener 27 with opening 31 oversized for the 20 fastener shank. With attention also to FIG. 6, it will be seen that base end 30A has inclined surfaces at 32. The inclined surfaces cooperate with housing inclined surfaces 33 with the surfaces 32 and 33 serving to return housing 25 into a pre-determined relationship with base 30 regardless of slight movement imparted to the housing during momentary tipping of post component 2 as, for example, by the wind. Accordingly, post component 2 may tip or rock in response to variable high winds but will always return to the pre-determined relationship with base 30. As in the earlier described form of the invention, the oversize openings 31 in base 30 and in housing 25 permit momentary lateral displacement of fastener 27. The immediately above described feature is of value to prevent any slight displacement of post component 2 when tipped.

While the present support has been shown and described for use in conjunction with mailboxes it will be understood that the novel support may be utilized in roadside or streetside signage to reduce replacement and/or repair costs of signs damaged by autos, trucks, etc. The post component 2, in such instances, would most likely be of linear configuration.

In FIG. 7, a modified post structure 2′ may be termed a sign post having a road sign thereon (not shown). Plates at 35 are carried by a housing 25 and a fastener assembly 36 couples the post lower end to the plate and the housing. Access to fastener 27 is achieved upon removal of post 2′.

While I have shown but one embodiment of the invention, it will be apparent to those skilled in the art that the invention may be embodied still otherwise without departing from the spirit and scope of the claimed invention.

Having thus described the invention, what is desired to be secured by a Letters Patent is:

1. A support for installation adjacent a road side,
a post structure,
a base having a load bearing surface on which the post structure rests,
a coupling including a fastener, a resilient member acted on by said fastener and urging said post structure into seated contact with said load bearing surface, and
said post structure including a housing normally in contact with the base and in pivotal partial contact with the base upon tipping of the post structure from a lateral applied force acting on the post structure,
said resilient member serving to subsequently return the post structure into seated contact with said base.

2. The support claimed in claim 1 additionally including a light post carried by said post structure.

3. The support claimed in claim 2 wherein said light post is slidably displaced in said post structure.

4. The support claimed in claim 3 wherein said light post includes a lantern.

5. The support claimed in claim 1 wherein said post structure includes a reinforcing plate.

6. The support claimed in claim 5 wherein said post structure includes upright members, said reinforcing plate integral with the upright members.

7. The support claimed in claim 1 wherein said post structure and said base define communicating openings of greater cross section than said fastener, substantially permitting lateral displacement of the fastener during momentary tipping of the post structure.

8. The support claimed in claim 1 wherein said post structure and said base include cooperating inclined surfaces serving to return the post structure to a pre-determined relationship with said base after momentary tipping of the post structure.

9. The support claimed in claim 6 wherein said post structure additionally includes upwardly diverging members terminating downwardly in supported engagement with said housing.
